(19) United States
(12) Patent Application Publication
(10) Pub. No.: US 2008/0302831 A1
(43) Pub. Date: Dec. 11, 2008

(54) Pump container with a pick-up port thereof

(76) Inventor: Chuan-Ying Wang, Taipei City (TW)

Correspondence Address: BUCKNAM AND ARCHER, 1077 NORTHERN BOULEVARD, ROSLYN, NY, 11576, US

(21) Appl. No.: 11/810,179

(22) Filed: Jun. 5, 2007

(51) Int. Cl. B65D 88/54; G01F 11/00; B67D 5/40; B67D 5/60

(52) U.S. Cl. 222/321.5; 222/377; 222/464.7; 222/331

(57) ABSTRACT

This invention relates to a pump container with a pick-up port, comprising a receiving portion at one end and a mouth portion at the other end of the container, a pump device having a pump fixed and enclosed within the mouth portion by a cap, the pump having a hollow tube with one end extending to the receiving portion, the other end being provided outside the mouth portion, a push button being provided at the top end of the pump device and connected with a discharge port, characterized in that an inclined surface is formed on the bottom end of the receiving portion, a pick-up port is located at the corner of the lowest point of the inclined surface. If the residue on the bottom of the pump container cannot be sucked up completely when it is about to be consumed up, the closing means is detached from the pick-up port so that the residual content on the bottom can be taken out thoroughly through the pick-up port.

### BACKGROUND OF THE INVENTION

1. Field of the invention

The present invention relates to a new pump container, more particularly to a pump container with a pick-up port for sucking up the residual content on the bottom portion of the pump container.

2. Brief Description of the Prior Art

The structure of a container with a pump device is widespread in daily life items for its handiness, especially widely used in receiving emulsions for bathing or cleaning purpose. As shown in FIG. 5, a conventional pump container (10′) generally comprises a receiving portion (11′) at one end and a mouth portion (12′) at the other end of the container (10′), a pump device (20′) having a pump (21′) fixed and enclosed within the mouth portion (12′) by a cap (13′), the pump (21′) having a hollow tube (22′, 22″) with one end extending to the receiving portion (11′), the other end being provided outside the mouth portion (12′), a push button (23′) being provided at the terminal and connected with a discharge port (24′).

In spite of the handiness of the pump container, the content of the pump container cannot be sucked up completely when it is about to be consumed up (usually the liquid level is approximately 0.5 cm from the bottom). The person skilled in the art can understand that the air within the container (10′) is sucked into the inlet port (22a′) of the hollow tube (22′) to destroy the vacuum state within the hollow tube (22′). It is this reason that the residual content on the bottom of the pump container cannot be sucked up completely when it is about to be consumed up. This is not only a waste, but also causes environmental pollution when the pump container with residual content is discarded. In most cases, user will detach the pump device (20′) from the container and then put some water into the container (10′) from the mouth portion (12′) for dilution, so as to use up the residual content. However, it is considered inconvenient in so doing, thus there is an expectation on the improvement of the conventional pump container.

### SUMMARY OF THE INVENTION

The main object of this invention is to provide a pump container with a pick-up port in such a manner that the defect of incapability of sucking up the residual content on the bottom of the pump container can be improved by the pick-up port provided at the lowest point of the bottom of the pump container.

In order to achieve the above and another objects, the pump container with a pick-up port comprises a receiving portion at one end and a mouth portion at the other end of the container, a pump device having a pump fixed and enclosed within the mouth portion by a cap, the pump having a hollow tube with one end extending to the receiving portion, the other end being provided outside the mouth portion, a push button being provided at the top end of the pump device and connected with a discharge port, characterized in that a pick-up port is formed at the lowest point on the bottom of the receiving portion and the pick-up port is closed by a closing means.

According to the present invention, an inclined surface is formed on the bottom of the receiving portion, the pick-up port is located at the corner of the lowest point of the inclined surface such that the residual content on the bottom flows to the pick-up port and is collected easily.

In so doing, if the residual content on the bottom of the pump container cannot be sucked up completely when it is about to be consumed up, the closing means is detached from the pick-up port so that the residual content on the bottom can be taken out thoroughly through the pick-up port. Therefore environment pollution by the residual content is avoided.

### BRIEF DESCRIPTION OF THE DRAWINGS

FIG. 1 is a perspective view showing the first embodiment of the new pump container with a pick-up port of the present invention.

FIG. 1a is a schematic partially exploded view showing the first embodiment of the present invention.

FIG. 1b is a partially sectional enlarged view showing the first embodiment of the present invention.

FIG. 1c is a schematic sectional view showing the variation of the first embodiment of the present invention.

FIG. 2 is a perspective view showing the second embodiment of the new pump container with a pick-up port of the present invention.

FIG. 2a is a schematic partially exploded view showing the second embodiment of the present invention.

FIG. 2b is a partially sectional enlarged view showing the second embodiment of the present invention.

FIG. 3 is a perspective view showing the third embodiment of the new pump container with a pick-up port of the present invention.

FIG. 3a is a schematic partially exploded view showing the third embodiment of the present invention.

FIG. 3b is a partially sectional enlarged view showing the third embodiment of the present invention.

FIG. 3c is a schematic sectional view showing the variation of the third embodiment of the present invention.

FIG. 4 is a perspective view showing the fourth embodiment of the new pump container with a pick-up port of the present invention.

FIG. 4a is a schematic partially exploded view showing the fourth embodiment of the present invention.

FIG. 4b is a partially sectional enlarged view showing the fourth embodiment of the present invention.

FIG. 4c is a schematic sectional view showing the variation of the fourth embodiment of the present invention.

FIG. 5 is a schematic partially exploded view showing a conventional pump container.

### DETAILED DESCRIPTION OF THE PREFERRED EMBODIMENTS

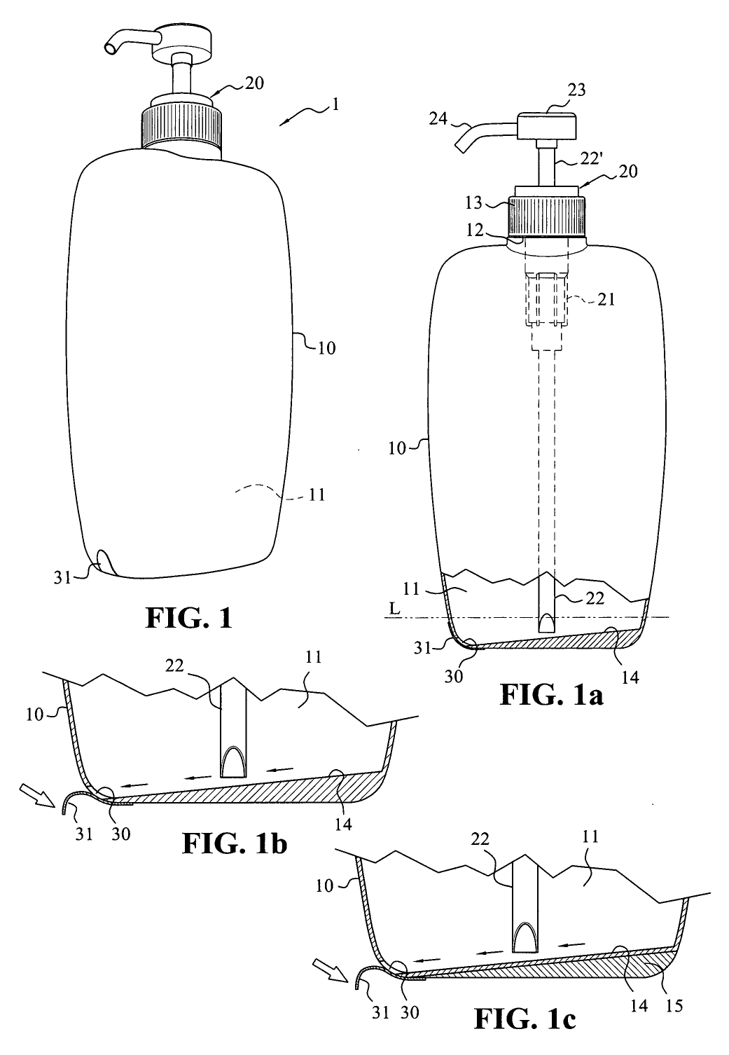

The technical features of the present invention will become more apparent by the detailed description of following embodiments, which are merely illustrative rather than restrictive on the scope of the present invention, in conjunction with the attached drawings. Firstly referring to FIG. 1, 1a and 1b, in which a pump container with a pick-up port of the first embodiment of the present invention are shown. The pump container 1 of the present invention, similar in basic configuration with that of a general conventional pump container, comprises a receiving portion 11 at one end and a mouth portion 12 at the other end of the container 10, a pump device 20 having a pump 21 fixed and enclosed within the mouth portion 12 of the container 10 by a cap 13, the pump 21 having a hollow tube 22, 22′ with one end extending to the receiving portion 11, the other end being provided outside the mouth portion 12, a push button 23 being provided at the top end of the pump device 11 and connected with a discharge port 24.

An inclined bottom surface 14 is provided at the bottom end of the receiving portion 11 of the container 10. A pick-up port 30 is provided at the lowest corner of the inclined bottom surface 14. A closing means 31 such as a film is detachably adhered on the outside of the pick-up port 30 and the pick-up port 30 is closed by a closing means 31. As shown in FIG. 1b, the wall thickness of the bottom surface 14 of the container 10 is formed in such a manner that the opposite side of the pick-up port 30 is thicker and then gradually becomes thinner toward the direction of the pick-up port 30. The whole container is integrally formed. In this way, if the residual content on the bottom of the pump container 1 cannot be sucked up completely when the content is about to be consumed up, the film 31 is then stripped off from the outside of the pick-up port 30 so that the residual content on the bottom can be taken out thoroughly through the pick-up port 30. Therefore environment pollution by the residual content is avoided.

The blow molding technology to form the inclined bottom surface 14 is of high-level technology. As one of the solutions, a pad 15 having larger thickness at the opposite side of the pick-up port 30 and then gradually becoming thinner toward the direction of the pick-up port 30 can also be used as a supplement attached to the underlying of the bottom of the container 10.

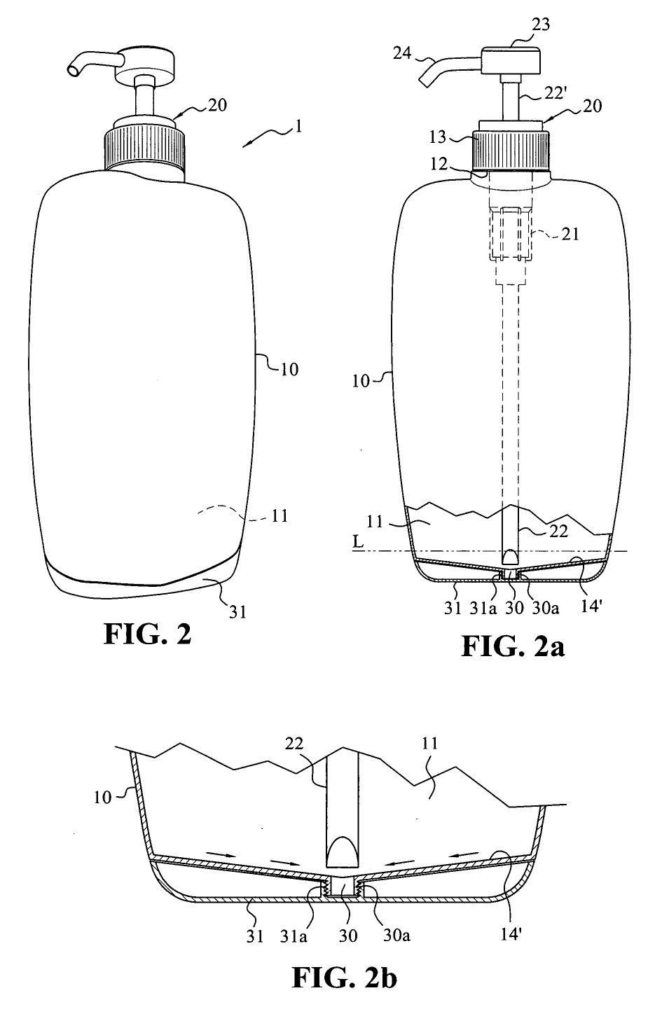

Next referring to FIG. 2, 2a, and 2b, in which the second embodiment of the pump container with a pick-up port of the present invention are shown. The basic configuration of the pump container 1 of this embodiment is substantially the same as that of the above embodiment, therefore repeated description is omitted.

In this embodiment, a hopper shape bottom 14′ with inclined surfaces from both sides to the center is formed at the bottom end of the receiving portion 11 of the container 10. A pick-up port 30 is formed at the lowest point of the bottom 14′, which has a downward-protruding tube portion 30a having outside thread on it. Corresponding to the shape of the bottom 14′ of the container 10, the closing means 31 is formed as a hopper with inclined surfaces from both sides to the center, which underlies the bottom 14′ of the container 10 as a complementary portion. A cap 31a is projected upwardly at the inner center of the closing means 31, which has a thread portion formed at inner diameter to engage with the tube portion 30a.

In this way, if the residual content on the bottom of the pump container 1 cannot be sucked up completely when the content is about to be consumed up, the closing means is released from the bottom of the container 10 such that the cap 31 a closing the pick-up port 30 is detached from tube portion 30a. Thus, the residual content on the bottom can be taken out thoroughly through the pick-up port 30. Therefore environment pollution by the residual content is avoided.

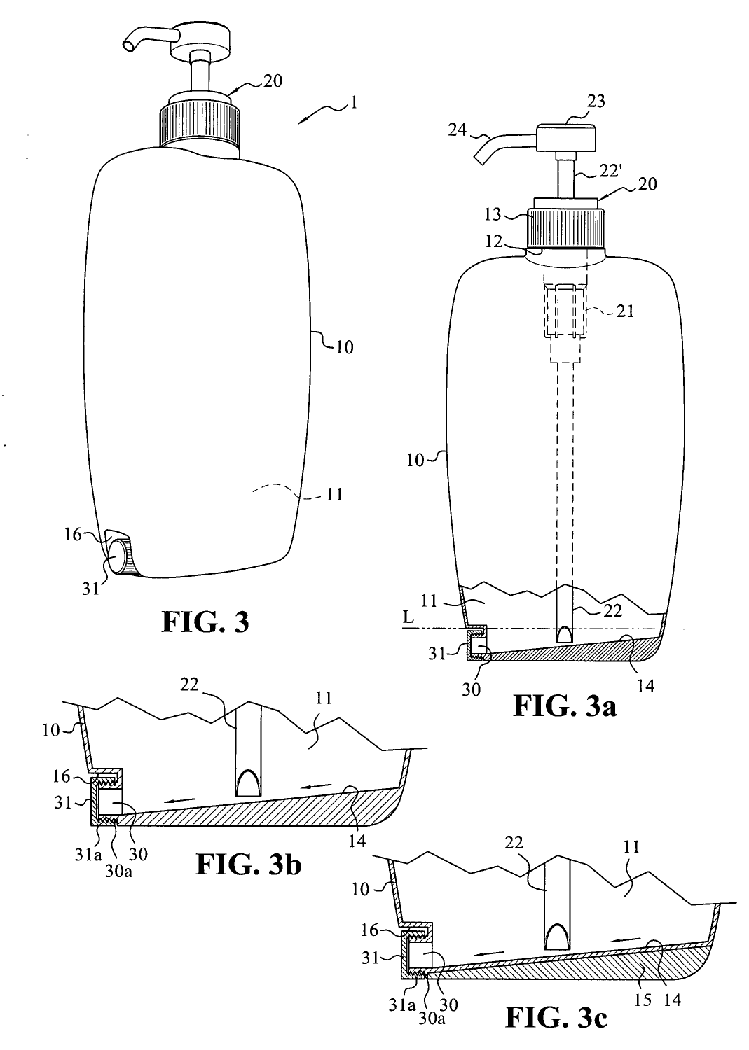

FIG. 3, 3a and 3b are the third embodiment of the pump container with a pick-up port of the present invention. In this embodiment, a recess portion 16 is formed at a corner of the lower end of the container 10. The bottom end of the receiving portion 11 forms a bottom surface 14 inclined toward this recess portion 16. The pick-up port 30 is located between the lowest point of the bottom surface 14 and the recess portion 16. The pick-up port 30 includes a tube 30a protruding toward the direction of the recess portion 16, which has an outside thread portion. Corresponding to the tube 30a of the pick-up port 30, the closing means 31 is formed with a cap 31a inside which is formed with a thread portion so as to engage with and close the tube 30a. As shown in FIG. 3b, the wall thickness of the bottom surface 14 of the container 10 is formed in such a manner that the opposite side of the pick-up port 30 is thicker and then gradually becomes thinner toward the direction of the pick-up port 30. The whole container is integrally formed. In this way, if the residue on the bottom of the pump container 1 cannot be sucked up completely when the content is about to be consumed up, the cap 31a closing the outside of the pick-up port 30 is released so that the residual content on the bottom can be taken out thoroughly through the pick-up port 30. Therefore environment contamination by the residual content is avoided.

In addition, a variation of the inclined bottom surface 14 is shown in FIG. 3c in which a pad 15 having larger thickness at the opposite side of the pick-up port 30 and then gradually becoming thinner toward the direction of the pick-up port 30 can also be used as a supplement attached to the underlying of the bottom of the container 10, such that the residual content on the bottom flows to the pick-up port and is collected easily.

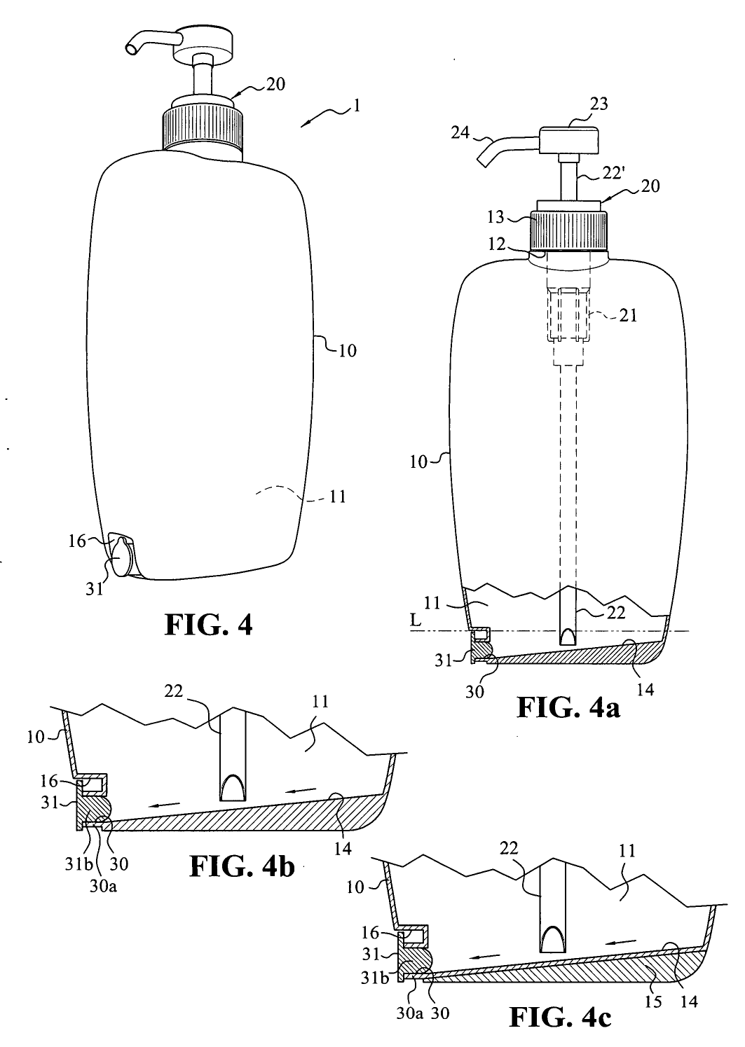

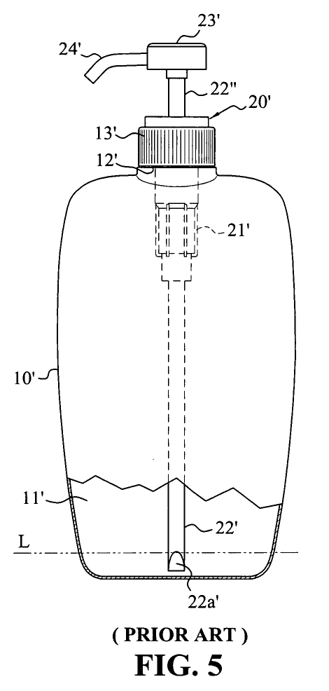

FIG. 4, 4a and 4b show the fourth embodiment of the pump container with a pick-up port of the present invention. In this embodiment, a recess portion 16 is formed at a corner of the lower end of the container 10. The bottom end of the receiving portion 11 forms a bottom surface 14 inclined toward this recess portion 16. The pick-up port 30 is located between the lowest point of the bottom surface 14 and the recess portion 16. The pick-up port 30 includes a tube 30a protruding toward the direction of the recess portion 16. Corresponding to the tube 30a of the pick-up port 30, the closing means 31 is formed with a cylindrical plug 31b, which is used to block and close the tube 30a. As shown in FIG. 4b, the wall thickness of the bottom surface 14 of the container 10 is formed in such a manner that the opposite side of the pick-up port 30 is thicker and then gradually becomes thinner toward the direction of the pick-up port 30. The whole container is integrally formed. In this way, if the residual content on the bottom of the pump container 1 cannot be sucked up completely when the content is about to be consumed up, the plug 31b closing the outside of the pick-up port 30 is removed so that the residual content on the bottom can be taken out thoroughly through the pick-up port 30. Therefore environment contamination by the residual content is avoided.

In addition, a variation of the inclined bottom surface 14 is shown in FIG. 4c in which a pad 15 having larger thickness at the opposite side of the pick-up port 30 and then gradually becoming thinner toward the direction of the pick-up port 30 can also be used as a supplement attached to the underlying of the bottom of the container 10, such that the residue on the bottom flows to the pick-up port and is collected easily.

The above embodiments are for illustrative purpose only, not for the restriction of the scope of the present invention. The equivalent modifications and variations made without departing from the spirit and principle of the present invention are still considered to be within the scope of the present invention.

What is claimed is:

1. A pump container (1) with a pick-up port, comprising a receiving portion (11) with a bottom at one end and a mouth portion (12) at the other end of the container (10), a pump device (20) having a pump (21) fixed and enclosed within said mouth portion (12) of said container (10) by a cap (13), said pump (21) having a hollow tube (22,22′) with one end extending into said receiving portion (11), the other end being provided outside said mouth portion (12) with, a push button (23) being provided at the top end of said pump device (11) and with a discharge port (24), wherein a pick-up port (30) is provided at the lowest point of the bottom of said receiving portion (11) and a closing means (31) is used to close the opening of said pick-up port (30).

2. A pump container (1) with a pick-up port according to claim 1, wherein an inclined bottom surface (14) is formed at the bottom of said receiving portion (11) of said container (10), said pick-up port (30) is located at the lowest corner of said inclined bottom surface (14).

3. A pump container (1) with a pick-up port according to claim 2, wherein said closing means (31) is a film detachably adhered on the outside of said pick-up port (30).

4. A pump container (1) with a pick-up port according to claim 3, wherein the wall thickness of said bottom surface (14) of said container (10) is formed in such a manner that the opposite side of the pick-up port (30) is thicker and then gradually becomes thinner toward the direction of the pick-up port (30), and the whole container is integrally formed.

5. A pump container (1) with a pick-up port according to claim 3, wherein a pad (15) having larger thickness at the opposite side of said pick-up port (30) and then gradually becoming thinner toward the direction of said pick-up port (30) is used as a supplement attached to the underlying of said bottom surface (14) of said container (10).

6. A pump container (1) with a pick-up port according to claim 1, wherein a hopper shape bottom (14′) with inclined surfaces from both sides to the center is formed at the bottom end of said receiving portion (11) of said container (10), said pick-up port (30) is formed at the lowest point of said bottom (14′).

7. A pump container (1) with a pick-up port according to claim 6, wherein said pick-up port (30) has a downward-protruding tube portion (30a) having outside thread on it.

8. A pump container (1) with a pick-up port according to claim 7, wherein corresponding to the shape of said bottom (14′) of said container (10), said closing means (31) is formed as a hopper with inclined surfaces from both sides to the center, which underlies said bottom (14′) of said container (10) as a complementary portion, a cap (31a) is projected upwardly at the inner center of said closing means (31), which has a thread portion formed at inner diameter to engage with the tube portion (30a).

9. A pump container (1) with a pick-up port according to claim 1, wherein a recess portion (16) is formed at a corner of the lower end of said container (10), the bottom end of said receiving portion (11) forming a bottom surface (14) inclined toward this recess portion (16), said pick-up port (30) being located between the lowest point of said bottom surface (14) and said recess portion (16).

10. A pump container (1) with a pick-up port according to claim 9, wherein said pick-up port (30) includes a tube (30a) protruding toward the direction of said recess portion (16), which has outside thread portion.

11. A pump container (1) with a pick-up port according to claim 10, wherein corresponding to said tube (30a) of said pick-up port (30), said closing means (31) is formed with a cap (31a) inside which is formed with a thread portion so as to engage with and close said tube (30a).

12. A pump container (1) with a pick-up port according to claim 11, wherein the wall thickness of said bottom surface (14) of said container (10) is formed in such a manner that the opposite side of said pick-up port (30) is thicker and then gradually becomes thinner toward the direction of said pick-up port (30), and the whole container is integrally formed.

13. A pump container (1) with a pick-up port according to claim 11, wherein a pad (15) having larger thickness at the opposite side of said pick-up port (30) and then gradually becoming thinner toward the direction of said pick-up port (30) is used as a supplement attached to the underlying of said bottom surface (14) of said container (10).

14. A pump container (1) with a pick-up port according to claim 9, wherein said pick-up port (30) includes a tube (30a) protruding toward the direction of said recess portion (16).

15. A pump container (1) with a pick-up port according to claim 14, wherein corresponding to said tube (30a) of said pick-up port (30), said closing means (31) is formed with a cylindrical plug (31b) which is used to block and close said tube (30a).

16. A pump container (1) with a pick-up port according to claim 15, wherein the wall thickness of said bottom surface (14) of said container (10) is formed in such a manner that the opposite side of said pick-up port (30) is thicker and then gradually becomes thinner toward the direction of said pick-up port (30), and the whole container is integrally formed.

17. A pump container (1) with a pick-up port according to claim 15, wherein a pad (15) having larger thickness at the opposite side of said pick-up port (30) and then gradually becoming thinner toward the direction of said pick-up port (30) is used as a supplement attached to the underlying of said bottom surface (14) of said container (10).
